(19) United States
(12) Patent Application Publication
(10) Pub. No.: US 2025/0215943 A1
(43) Pub. Date: Jul. 3, 2025

(54) BRAKE CALIPER OF THE FLOATING TYPE OF A DISC BRAKE

(71) Applicant: Brembo S.p.A., Curno (IT)

(72) Inventors: Elena MARENGHI, Curno (IT); Giuseppe DONADONI, Curno (IT); Matilde PAIANO, Curno (IT); Claudio LOCATELLI, Curno (IT); Tommaso MORICCI, Curno (IT); Raffaele MILANESE, Curno (IT); Alfredo EPIS, Curno (IT); Emanuele PIATTI, Curno (IT)

(21) Appl. No.: 19/001,816

(22) Filed: Dec. 26, 2024

(30) Foreign Application Priority Data
Dec. 28, 2023 (IT) 102023000028188

(51) Int. Cl. F16D 65/00; F16D 55/00; F16D 55/226

(52) U.S. Cl. CPC F16D 65/0068; F16D 55/226; F16D 2055/0016

(57) ABSTRACT

The present invention relates to a brake caliper (1) of the floating type of a disc brake (100) comprising:
a bracket or support element (2) configured to be connected to a vehicle,
a caliper body or floating element (3),
wherein the caliper body (3) comprises a first caliper body portion or caliper body vehicle-side portion (3.1), wherein the first caliper body portion (3.1) delimits at least one housing seat (5) for thrust means (5a);
wherein the caliper body (3) comprises a second caliper body portion or cantilevered caliper body portion (3.2), wherein the second caliper body portion (3.2) projects from the first caliper body portion (3.1) at least partially in the axial direction (A-A) so that the caliper body (3.2) can be arranged straddling a brake disc (4), wherein said second caliper body portion (3.2) comprises a first part (3a) of second caliper body portion which is opposite to said first caliper body portion (3.1);
at least one caliper body sliding guide or caliper body guide pin (11), wherein said at least one caliper body sliding guide (11) is arranged between said caliper body (3) and said bracket (2) to allow a relative sliding between the caliper body (3) and the bracket (2) along an axial direction (A-A);
at least a first and a second pad (6a,6b) having a support plate (7) and a friction material lining (8), said pads (6a,6b) being each positionable on a side of a brake disc (4) of said disc brake (100) facing opposite braking surfaces (4a) of a braking band (4b) of the brake disc (4);
said brake disc (4) being a rotor adapted to rotate about a rotation axis (10) which defines said axial direction (A-A), parallel to said rotation axis (10), a radial direction (R-R), orthogonal to said rotation axis (10), and a circumferential direction (C-C) orthogonal to said radial (R-R) and axial (A-A) directions;
pad guide elements (12a, 12b) interposed between said pads (6a,6b) and said bracket (2), wherein said pad guide elements (12a,12b) comprise at least a first pad guide pin (12a) supported by said bracket (2) and extending in the axial direction (A-A), at least said first pad (6a) being slidingly mounted to said first pad guide pin (12a) so as to allow said first pad (6a) to slide in the axial direction (A-A) along said first pad guide pin (12a);
at least one spring (15), shaped to be arranged straddling the brake disc (4) or to be arranged so as to extend from two opposite sides with respect to the brake disc (4), wherein said spring (15) applies an elastic bias to said pads (6a,6b) so as to elastically bias said pads (6a,6b) away from the brake disc (4) and so as to cause, by means of said second pad (6b), the caliper body to slide in said axial direction (A-A), in the direction in which the first part (3a) of second caliper body portion moves away from the brake disc (4);
wherein said spring (15) is also connected to said bracket (2) in addition to being connected to said pads (6a,6b).

### FIELD OF THE INVENTION

The present invention relates to a floating brake caliper as well as to a disc brake comprising such a caliper.

### PRIOR ART

In a floating caliper disc brake., the brake caliper is typically arranged straddling the outer peripheral margin of a brake disc. The brake caliper usually comprises a body having two elongated elements, or portions, which are arranged so as to face opposite braking surfaces of a disc. Friction pads are provided arranged between each elongated element of the caliper and the braking surfaces of the brake disc. At least one of the elongated elements of the caliper body has at least one actuator, e.g., a cylinder adapted to accommodate a hydraulic piston capable of applying a thrust action to the pads, abutting them against the braking surfaces of the disc to apply a braking action to the vehicle.

The brake calipers are usually constrained to a support structure, which remains firmly connected to the vehicle, such as a suspension of a vehicle, more particularly a fork or swingarm of the suspension in the case of a motorcycle, for example.

In a typical arrangement, one of the two elongated elements has two or more attachment portions for attaching the caliper body to the support structure, for example by providing slots or eyelets, e.g., arranged axially, or through holes, e.g., arranged radially, adapted to receive screws for fixing the caliper, which are accommodated with the ends thereof in threaded holes provided on the caliper support.

In a typical caliper body construction, the elongated elements arranged facing the braking surfaces of the disc are mutually connected by bridge-like elements arranged straddling the disc.

In particular, a service and/or parking disc brake comprises a brake disc which rotates together with a wheel of a vehicle. Brake pads face the brake disc and are accommodated in a brake caliper placed straddling said brake disc. The pads are biased either directly or indirectly to abut against the opposite braking surfaces of the brake disc by actuation means of various types, including hydraulic means or, especially in the case of parking brakes, lever means.

In particular, in a floating caliper disc brake, the brake pad on one side, usually the side facing the vehicle, is displaced with respect to the caliper because it is biased by thrust means, e.g., a piston housed in the caliper body, and biased by brake fluid pressurized by the command of the vehicle driver, towards the disc.

The brake pad on the other side of the disc, e.g., the side facing the vehicle wheel, is typically fixed with respect to the caliper. In order to provide a clamping force on both sides of the disc, the caliper body moves axially with respect to the brake disc when the brake is actuated, to take the brake pad, which is fixed to the caliper, into contact with the brake disc. The caliper body also moves axially with respect to the brake disc to allow for pad and disc wear. Such a disc brake is known, for example, from U.S. Pat. No. 4,685,686, as well as from EP3633224, JP2017214962, JP2019128023, WO2020189356.

To allow this, the caliper is typically mounted on a brake carrier or brake support or bracket by means of two guide pins.

In a typical caliper construction, the bracket defines a sliding system for the pads, equipped with sliding springs, which resists braking torque. Such a sliding system has the drawback of requiring a relatively large number of components and processes to be manufactured. The typical structure of the pad sliding system defined in the bracket is also relatively heavy.

In brake calipers, it is known to provide disc brake springs consisting of a central portion and two end portions, where the end portions rest against the pads so as to bias the pads elastically away from each other to ensure a separation of the pads from the brake disc after each braking action.

The known springs are normally used to obtain a three-fold effect:
reducing the vibrations of the pads;
moving the pads away from the brake disc to reduce or eliminate a residual braking torque (residual torque) due to undesired contacts between the pads and the brake disc with the brake deactivated;
obtaining uniform wear of the friction linings of the pads.

Usually, the known springs are kept in their operating position by fixing the central portion of the springs to the caliper body.

In particular, the springs of the prior art generally comprise one or more connection legs, formed at the central portion of the spring, adapted to connect the spring to the caliper at coupling portions formed on the caliper body or on the pads.

A drawback of these known solutions in which the springs are connected to the caliper body or pads is due to the fact that they fail to ensure a proper centering of the caliper body with respect to the braking band of the brake disc at the end of the braking action, which results in negative effects in terms of residual torque.

A further drawback of the known solutions mentioned above in which the springs are connected to the caliper body or pads is due to the fact that the springs are typically arranged in staggered positions in the circumferential direction with respect to the caliper body sliding guides. Therefore, such an arrangement of the springs causes an increase in the overall dimensions of the brake caliper in the circumferential direction.

### OBJECT OF THE PRESENT INVENTION

It is a general object of the present invention to provide a solution which allows solving or obviating at least partially the drawbacks described above with reference to brake calipers of the prior rt.

Additionally or alternatively to the aforesaid object, it is a particular object of the present invention to provide a solution which allows improving the performance of the brake caliper in terms of residual torque, in particular at the end of the braking action.

Additionally or alternatively to the aforesaid objects, it is a particular object of the present invention to provide a solution which allows reducing the dimensions of the caliper in a circumferential direction.

Additionally or alternatively to the aforesaid objects, it is a particular object of the present to provide a solution which allows reducing the number of components and/or the number of processes required for manufacturing the brake caliper and particularly the related pad sliding system.

Additionally or alternatively to the aforesaid objects, it is a particular object of the present invention to provide a solution which allows reducing the weight of the brake caliper.

These and other objects are achieved by a brake caliper as defined in appended claim 1 in the most general form thereof and in the dependent claims in several particular embodiments. The present invention also relates to a brake disc as defined in claim 14.

### DRAWINGS

In order to better understand the invention and appreciate the advantages thereof, some non-limiting exemplary embodiments thereof will be described below with reference to the accompanying drawings, in which:

FIG. 1 is a perspective view of a floating brake caliper according to an embodiment of the invention;

FIG. 2 is a further front plan view in which a disc brake comprising the brake caliper in FIG. 1 is partially depicted, in which, in particular, such a caliper is arranged straddling a braking band, partially depicted in the figure, of the brake disc;

FIG. 3 is a top plan view of the caliper in FIG. 1;

FIG. 4 is a bottom plan view of the caliper in FIG. 1;

FIG. 5 is a side plan view of the brake caliper in FIG. 1;

FIG. 6 is a plan view in which the brake caliper is shown in a cross section according to line P-P in FIG. 2;

FIG. 7 is a plan view in which the brake caliper is shown in a cross section according to line Q-Q in FIG. 3;

FIG. 8 is a perspective view of the brake caliper or floating element of the brake caliper in FIG. 1;

FIG. 9 is a perspective view of a spring of the caliper in FIG. 1;

FIG. 10 is a side plan view of the spring in FIG. 9;

FIG. 11 is a perspective view of a bracket of the brake caliper in FIG. 1;

FIG. 12 is a top plan view of an assembly comprising two springs in FIG. 9 and a bracket in FIG. 11, which supports two caliper body sliding guides in FIG. 8 and two brake caliper pads by means of the respective pad guide pins;

FIG. 13 is a front plan view in which a pad of the brake caliper in FIG. 1 and two springs in FIG. 9 in contact with the pad are shown, in such a figure the pad being observed from the opposite side with respect to that shown in FIG. 7;

FIG. 14 is a perspective view of a first guide pin of a pad of the brake caliper in FIG. 1, which is shown in FIG. 6;

FIG. 15 is a perspective view of a second guide pin of a pad of the brake caliper in FIG. 1, which is shown in FIG. 6;

FIG. 16 is a perspective view of a sliding guide of the caliper body shown in FIG. 6.

### DETAILED DESCRIPTION OF SOME EMBODIMENTS OF THE INVENTION

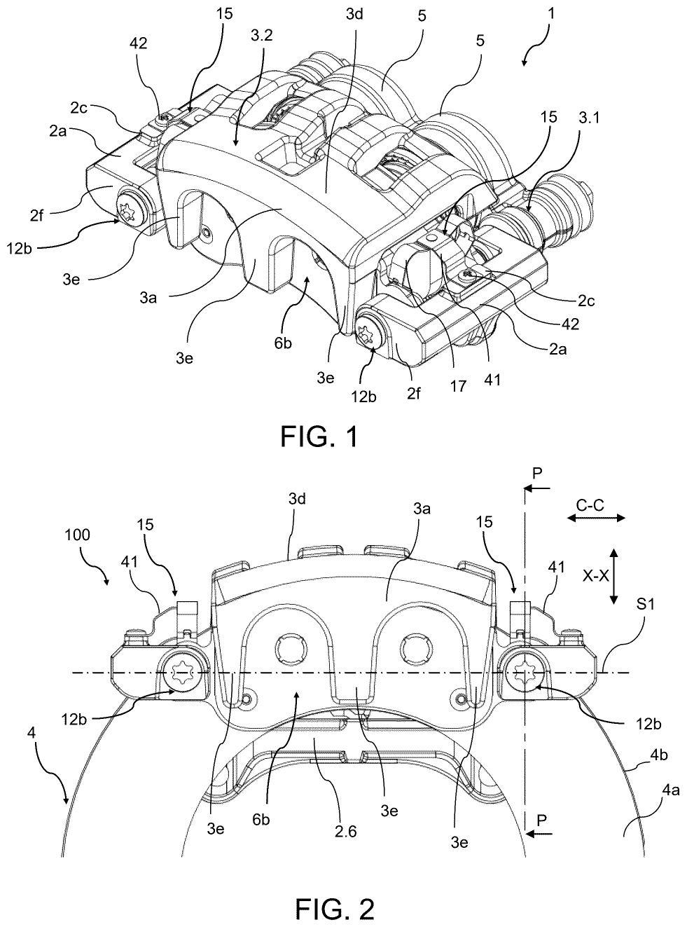

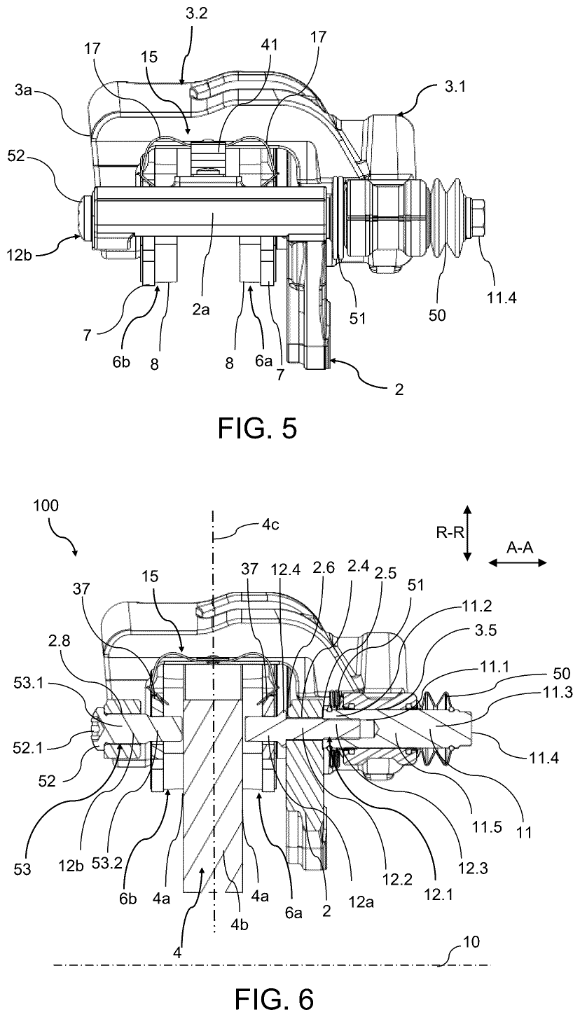

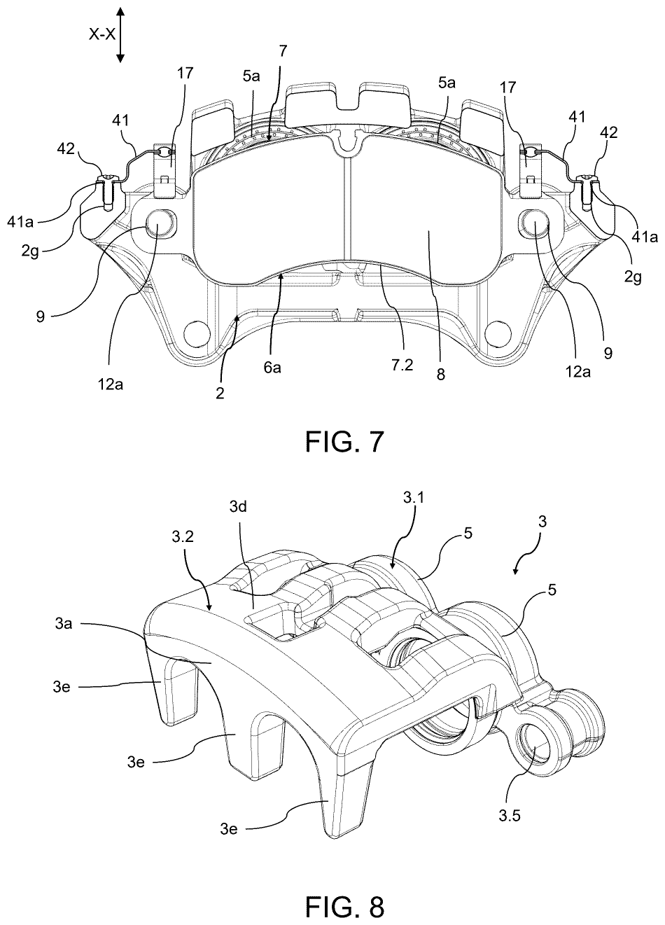

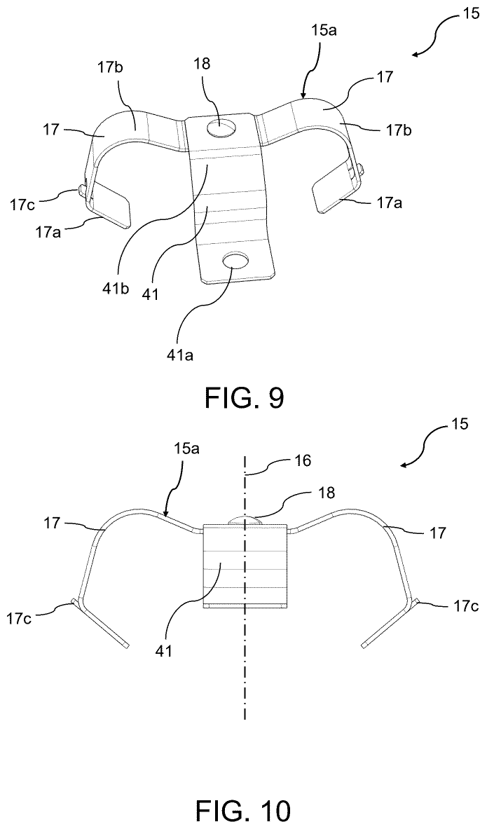

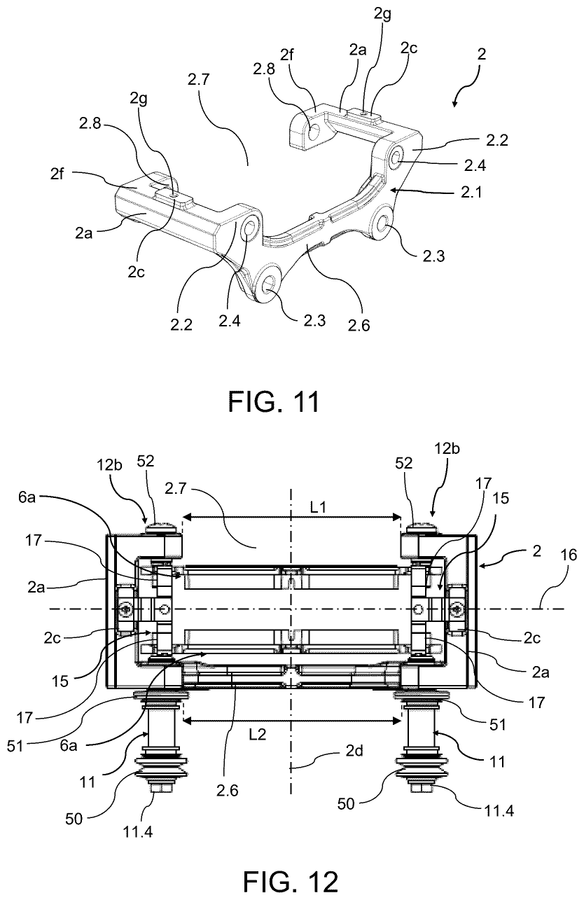

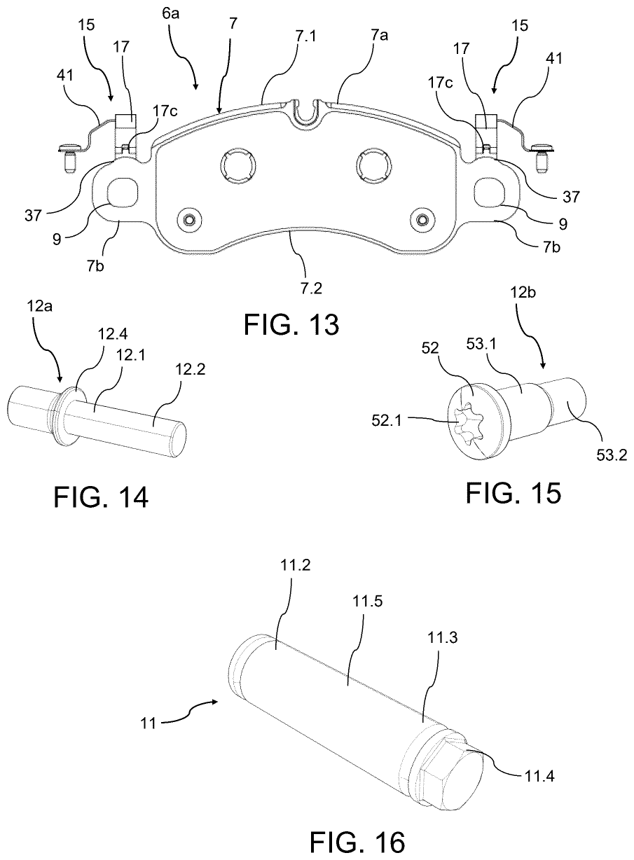

With reference to the FIGS. 1 through 16, a disc brake, in particular for use on motor vehicles, is indicated by reference numeral 100 as a whole. Specifically, it is a disc brake of the floating caliper type.

The disc brake 100 comprises a floating brake caliper 1 and a brake disc 4, where the brake disc 4 defines a rotation axis 10. The caliper 1 comprises a bracket or support element or support of the brake 2 configured to be connected to a vehicle and a caliper body or floating element 3. According to an embodiment, the bracket 2 is fixed to a vehicle suspension, while the brake disc 4, provided with an annular braking band, is connectable to the wheel hub of the vehicle (not shown).

The brake disc 4 is a rotor adapted to rotate about a rotation axis 10 which defines an axial direction A-A, parallel to the rotation axis 10, a radial direction R-R, orthogonal to the rotation axis 10, and a circumferential direction C-C, orthogonal to the axial A-A and radial R-R directions. According to an embodiment, the rotation axis 10 further defines a tangential direction T-T punctually orthogonal to a radial direction R-R and a circumferential direction C-C at the point of intersection thereof.

According to an embodiment, the caliper body 3 comprises a first caliper portion or caliper body vehicle-side portion 3.1. The first caliper body portion 3.1 delimits at least one housing seat 5 for thrust means 5a. According to an embodiment, the thrust means 5a comprise at least one actuator 5a, such as a hydraulic cylinder-piston assembly 5a, for example, housed in the at least one seat 5. According to an embodiment, the first caliper body portion 3.1 delimits two housing seats 5, in which the aforesaid thrust means 5a are housed.

According to an embodiment, the caliper body 3 further comprises a second caliper body portion or cantilevered caliper body portion 3.2, where the second caliper body portion 3.2 projects from the first caliper body portion 3.1 at least in the axial direction A-A. In particular, according to an embodiment, the second caliper body portion 3.2 projects from the first caliper body portion 3.1 at least in the axial direction A-A on a side opposite to the vehicle. According to an embodiment, the second caliper body portion 3.2 projects from the first caliper body portion 3.1 at least in the axial direction A-A so that the caliper body 3.2 can be arranged straddling a brake disc 4. According to an embodiment, the first caliper body portion 3.1 and the second caliper body portion 3.2 are arranged so as to face opposite braking surfaces 4a of the brake disc 4. More in particular, according to an embodiment, the second caliper body portion 3.2 comprises a first part 3a of second caliper body portion. According to an embodiment, the first part 3a of the second caliper body portion 3.2 is opposed to and spaced apart in the axial direction A-A from the first caliper body portion 3.1. In other words, according to an embodiment, the first part 3a of second caliper body portion is opposite to the first caliper body portion 3.1. According to an embodiment, the first caliper body portion 3.1 and the first part 3a of the second caliper body portion 3.2 are arranged so as to face opposite braking surfaces 4a of the brake disc 4.

According to an embodiment, the second caliper body portion 3.2 comprises a caliper body connection portion or bridge-like connection portion 3d which connects the first caliper body portion 3.1 and the first part 3a of the second caliper body portion 3.2 so that the caliper body 3 is adapted to be arranged straddling the brake disc 4.

According to an embodiment, the second caliper body part 3.2, and more preferably the first part 3a of second caliper body portion, comprises one or more elongated portions or reaction teeth 3e, which face and are adapted to contact a second pad 6b, which will be described below in the present description. According to an embodiment, the second caliper body part 3.2 comprises at least an elongated portion 3e which extends in a radial direction R-R up to a lower edge 7.2 of a support plate 7 of the second pad 6b or until it is close to such a lower edge 7.2.

The caliper 1 comprises at least one caliper body sliding guide or caliper body guide pin 11. According to an embodiment, the caliper 1 comprises two caliper body sliding guides or caliper body guide pins 11, which are arranged on two opposite sides with respect to the pads 6a,6b, which will be described below in the present description. The at least one caliper body sliding guide 11 is arranged between the caliper body 3 and the bracket 2 to allow a relative sliding between the caliper body 3 and the bracket 2 along an axial direction A-A. In other words, the at least one brake caliper sliding guide 11 is supported, either directly or indirectly, by the bracket 2 to allow a relative sliding between the caliper body 3 and the bracket 2 along an axial direction A-A. According to an embodiment, which will be described below in the present description, the at least one caliper body sliding guide 11 is, for example, indirectly supported by the bracket 2 by means of at least a first pad guide pin 12a.

The caliper 1 comprises at least two pads 6a,6b. In particular, the caliper 1 comprises at least a first pad 6a and at least a second pad 6b. According to an embodiment, as in the example shown in the accompanying figures, the first and second pads 6a,6b are structurally the same. Each pad 6a,6b comprises a support plate 7, e.g., made of steel, and a friction material lining 8. Each pad 6a,6b can be positioned on one side of the brake disc 4 of the disc brake 100 so that the first and second pads 6a,6b face opposite braking surfaces 4a of a braking band 4b of the brake disc 4. The pads 6 are mainly displaceable in the axial direction A-A (parallel to the rotation axis 10 of the brake disc 4) towards the brake disc 4 by the aforesaid thrust means 5a, so as to clamp, by means of the friction material 8, a sector of the braking band 4b, the surface and shape of which preferably corresponds to that of the friction lining 8.

According to a possible embodiment, the support plate 7 of each pad 6 is preferably substantially planar. According to an embodiment, the support plate 7 has a central portion 7a and preferably forms two ears 7b protruding outwards from the support plate 7. In particular, according to an embodiment, the two ears 7b extend outwards from the support plate 7 in the circumferential direction C-C. According to an embodiment, each of the ears 7b forms a plate engagement portion or plate support portion 37. According to an embodiment, the central portion 7a preferably substantially has the shape of a distorted rectangle. According to an embodiment, the central portion 7a has an upper edge 7.1 and a lower edge 7.2 opposed to the upper edge 7.1. Preferably, the upper edge 7.1 is substantially convex, while the lower edge 7.2 is substantially concave. According to an embodiment, each pad 6a,6b comprises one or more eyelets 9, which are preferably obtained in the plate 7 outside the zone in which the friction material 8 is provided and more preferably in the ears 7b. Each eyelet 9 is intended to accommodate, preferably with clearance, a respective first pad guide pin 12a or second pad guide pin 12b of the caliper 1, which will be described in more detail below in the present description.

According to an embodiment, each pad 6a,6b is provided with two of such eyelets 9. According to an advantageous embodiment, the eyelets 9 are provided according to the solution described in the patent application published under number WO2010010583 to Freni Brembo S.p.A. Conveniently, the geometry of the eyelets 9 allows avoiding or at least limiting the noises generated by the pads 6a,6b mutually hitting (clang noise).

According to an embodiment, the caliper 1 comprises pad guide elements 12a, 12b interposed between the pads 6a,6b and the bracket 2. The guide elements 12a, 12b are arranged and configured to allow the pads 6a,6b to slide in the axial direction A-A.

According to an embodiment, the pad guide elements 12a, 12b comprise the aforesaid at least a first pad guide pin 12a. The at least a first pad pin 12a is supported by the bracket 2 and extends in the axial direction A-A.

According to an embodiment, the at least a first pad guide pin 6a is supported either directly or indirectly by the bracket 2. According to an embodiment shown in the accompanying figures and which will be described in more detail below in the present description, the at least a first pad guide pin 12a is directly supported by the bracket 2. At least the first pad 6a is slidingly mounted to the at least a first pad guide pin 12a so as to allow the first pad 6a to slide in the axial direction A-A along the at least a first pad guide pin 12a.

According to an embodiment, the pad guide elements 12a, 12b comprise the aforesaid at least a second pad guide pin 12b. The at least a second pad guide pin 12b is supported by the bracket 2 and extends in the axial direction A-A. According to an embodiment, the at least a first pad pin 12a is a pin of a first type, and the at least a second pad guide pin 12b is a pin of a second type pin having a conformation other than that of the first-type pin. According to an embodiment, the at least a second pad guide pin 12b is opposed to and faces the at least a first pad guide pin 12a. More in particular, according to an embodiment, the at least a second pad guide pin 12b is arranged coaxial to the at least a first pad guide pin 12a. According to an embodiment, the second pad 6b is slidingly mounted to the at least a second pad guide pin 12b so as to allow the second pad 6b to slide in the axial direction A-A along the at least a second pad guide pin 12b.

According to an embodiment, the guide elements 12a, 12b comprise a pair of first pad guide pins 12a arranged on two opposite sides with respect to the pads 6a,6b, or two opposite sides in the circumferential direction C-C with respect to the pads 6a,6b. According to an embodiment, the guide elements 12a, 12b further comprise a pair of second pad guide pins 12b, each of which is opposed to and faces a respective first pad guide pin 12a. According to an embodiment, the first pad 6a is slidingly mounted, preferably by means of the respective eyelets 9, to the pair of first pad guide pins 12a. According to an embodiment, the second pad 6b is slidingly mounted, preferably by means of the respective eyelets 9, to the pair of second pad guide pins 12b.

According to an alternative embodiment (not shown), both pads 6a,6b can be slidingly mounted to at least the same pad guide pin which is supported by the bracket 2 and which extends in axial direction A-A. For example, according to the embodiment, such an at least the same single guide pin to which both pads 6a,6b are slidingly mounted can be obtained by avoiding the provision of the at least a second pad guide pin 12b and increasing the extension in the axial direction A-A of the at least a first pad guide pin 12a.

According to an embodiment, the pads 6a,6b are mounted suspended from the at least a first pad guide pin 12a or the at least a second pad guide pin 12b. In particular, according to an embodiment, the first pad 6a is mounted suspended from the at least a first pad guide pin 12a and the second pad 6b is mounted suspended from the at least a second pad guide pin 12b. In other words, according to an embodiment, the lower edge 7.2 of the pads 6a,6b is a free edge. In yet other words, according to an embodiment, the lower edge 7.2 of the pads 6a, 6b is not in contact with or avoids contacting other components of the caliper 1. In yet other words, according to an embodiment, each pad 6a,6b is configured to slide exclusively along the at least a first pad guide pin 12a or the at least a second pad guide pin 12b.

The caliper 1 comprises at least one spring 15, shaped to be arranged straddling the brake disc 4 or extend from two opposite sides of the brake disc 4. The spring 15 applies an elastic bias to said pads 6a,6b so as to bias the pads 6a, 6b elastically away from the brake disc 4 and so as to bias, by means of the second pad 6b, a sliding of the caliper body 3 in the axial direction A-A, in the direction in which the first part 3a of second caliper body portion moves away from the brake disc 4. Advantageously, the at least one spring 15 is also connected to the bracket 2 in addition to the pads 6a,6b. According to an embodiment, the spring 15 is connected exclusively to the pads 6a,6b and the bracket 2. By connecting the at least one spring 15 to the bracket 2, it is advantageously possible to keep the spring 15 in a predetermined position with respect to a fixed element of the caliper 1, specifically the bracket 2, so as to allow centering the pads 6a,6b, and therefore the caliper body 3, at the end of the braking action, in particular by means of the pad 6b arranged axially further away from the thrust means 5a, which pushes on the second portion 3.2 of the caliper body 3, with respect to the centerline plane 4c of the braking band 4b which is orthogonal to the rotation axis 10 of the brake disc 4 or the axial direction A-A. In other words, according to an embodiment, upon releasing the pressure on the brake disc 4, the spring 15 takes an initial configuration again by moving the pads 6a, 6b symmetrically away from the portion of the bracket 2 to which the spring 15 is fixed, thus ensuring the centering of the pads 6a,6b and the caliper body 3 with respect to the centerline plane 4c of the braking band 4b of the brake disc 4. By virtue of the centering of the pads 6a,6b and the caliper body 3 with respect to the centerline plane 4c of the braking band 4b, it is therefore advantageously possible to improve the performance of the caliper 1 in terms of residual torque.

According to an embodiment, the caliper 1 comprises two springs 15 shaped or configured to be arranged straddling the brake disc 4 or to be arranged so as to extend from two opposite sides with respect to the brake disc 4. According to an embodiment, the two springs 15 are arranged on two opposite sides with respect to the pads 6a,6b or two opposite sides in the circumferential direction C-C with respect to the pads 6a,6b. According to an embodiment, each of the two springs 15 is configured so as to be directly connected exclusively to the pads 6a, 6b and the bracket 2. According to an embodiment, each springs 15 is connected to opposite sides of the two pads 6a,6b. According to an embodiment, each spring 15 is removably coupled to the pads 6a,6b and the bracket 2.

According to an embodiment, the bracket 2 comprises at least one bracket coupling seat or bracket fixing seat 2c to which the at least one spring 15 is connected. The bracket coupling seat 2c is located at a predetermined portion of the bracket 2 intended to be aligned with the aforesaid centerline plane 4c of the braking band 4b. According to an embodiment, the bracket coupling seat 2c is located in a position in the axial direction A-A which is central with respect to the support plates 7 of the two pads 6a,6b when the pads 6a,6b take an initial configuration corresponding to a deactivated brake state (not shown) and/or when the pads 6a,6b take a braking configuration corresponding to a braking state of the caliper 1 (FIGS. 6 and 12).

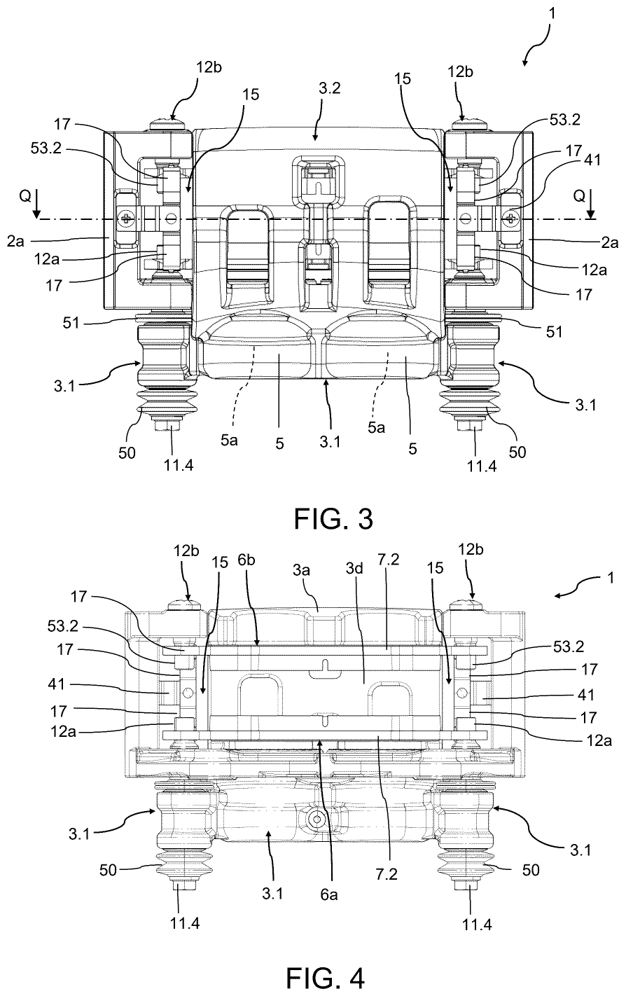

According to an embodiment, the at least one spring 15 defines a spring symmetry plane 16 and either comprises or consists of two side spring coupling portions or side spring arms 17 and a central spring coupling portion or central spring arm 41, which is interposed between, and either connected to or joined to, the side spring coupling portions 17. The side spring coupling portions 17 are symmetric with respect to the spring symmetry plane 16 and are configured to engage two respective opposite plate engagement portions 37 of the pads 6a,6b. According to an embodiment, the side spring coupling portions 17 extend and are aligned with each other in an axial direction A-A (FIGS. 3, 4, and 12). According to an embodiment the central spring coupling portion 41 extends in a circumferential direction C-C or in a direction orthogonal to the side spring coupling portions 17 (FIGS. 3, 4 and 12). According to an embodiment, the side spring coupling portions 17 are coupled in a support relationship with opposite plate engagement portions 37 of the pads 6a,6b. In other words, the side support portions 17 rest on and are adapted to apply an elastic thrust action to the pad coupling portions 37 avoiding from being coupled or otherwise fixed to the plate engagement portions 37. According to an embodiment, each of the side spring coupling portions 17 comprises a thrust end portion 17a which is adapted to apply an elastic thrust action to a respective plate engagement portion 37. According to an embodiment, each thrust end portion 17a is adapted to apply an elastic thrust action to a respective plate engagement portion 37 so as to bias the pads 6a,6b away from the brake disc 4 in the axial direction A-A and in the radial direction R-R or in an alignment direction X-X, which will be defined in greater detail below in the present description. According to an embodiment, when under operating conditions each thrust end portion 17a is arranged inclined with respect to an axial direction A-A as well as with respect to a radial direction R-R or the alignment direction X-X. In particular, according to an embodiment, each thrust end portion 17a forms a predefined angle between the thrust end portion 17a and the axial direction A-A and forms a predefined angle between the thrust end portion 17a and the radial direction R-R or the alignment direction X-X. According to an embodiment, each side coupling portion 17 of the spring 15 comprises a respective protruding mounting portion or protruding mounting tooth 17c. According to an embodiment, each protruding mounting portion 17c extends from a respective thrust end portion 17a in a direction opposite to such a thrust end portion 17a. The protruding mounting portions or protruding mounting teeth 17c have the function of keeping the spring 15 in place during assembly and avoiding the spring 15 from slipping between the pads 6a,6b and the brake disc 4.

According to an embodiment, each plate engagement portion 37 either comprises or consists of a protruding support portion or support hump projecting from a respective ear 7b to create a support zone for a respective side spring coupling portion 17 and more preferably for a respective thrust end portion 17a. The central spring coupling portion 41 is configured to couple to the bracket 2. The at least one spring 15 is arranged so that said spring symmetry plane 16 either coincides or substantially coincides with the centerline plane 4c of the braking band 4b of the brake disc 4. According to an embodiment, the central spring coupling portion 41 extends either mainly or entirely along a direction parallel to the spring symmetry plane 16.

According to an embodiment, the central spring coupling portion 41 is fixed to the bracket coupling seat 2c. According to an embodiment, the central spring coupling portion 41 is fixed to the bracket 2 so as to maintain the central spring coupling portion 41 in a fixed position at least in the axial direction A-A so as to prevent the central spring coupling portion 41 from moving in the axial direction A-A with respect to the bracket 2. According to an embodiment, the central spring coupling portion 41 is removably fixed to the bracket coupling seat 2c. According to an embodiment, the central spring coupling portion 41 is fixed to the seat 2c by means of at least one spring fixing screw 42, which is adapted to cross a spring fixing opening 41a provided in the central spring coupling portion 41 to be screwed into a corresponding bracket fixing hole 2g provided in the bracket coupling seat 2c.

According to an embodiment, the at least one spring 15 is a strip spring. In particular, according to an embodiment, the at least one spring 15 comprises a plate-like spring body 15a. According to an embodiment, the spring body 15a is obtained from a shaped, folded cut sheet metal of predetermined spring thickness. According to an embodiment, the spring body 15a either comprises or consists of a first spring strip 17b and a second spring strip 41b. According to an embodiment, the first spring strip 17b either comprises or defines the two side spring coupling portions 17. According to an embodiment, the second spring strip 41b either comprises or defines the central spring coupling portion 41. According to an embodiment, the first and second spring strips 17b,41b are fixed or firmly joined together by means of at least one spring fixing element 18, such as a fixing rivet 18, for example. According to an embodiment, the at least one spring 15 is made of metal, e.g., steel, preferably spring steel.

According to an embodiment, the bracket 2 defines a bracket symmetry plane 2d orthogonal to the spring symmetry plane 16. According to an embodiment, at least one of the side spring coupling portions 17 is at least partially aligned with the first pad guide pin 12a along an alignment direction X-X. Indeed, by virtue of the arrangement of the spring 15, it is possible to reduce the dimensions of the caliper 1 in the circumferential direction C-C. The alignment direction X-X is orthogonal to a plane which is orthogonal to both the spring symmetry plane 16 and the bracket symmetry plane 2d. According to an embodiment, having defined a caliper body sliding plane S1 passing through the central axes or symmetry axes of the pair of first pad guide pins 12a and/or the central axes or symmetry axes of the pair of second pad guide pins 12b, the alignment direction X-X is orthogonal to the plane S1.

According to an embodiment, both the two side spring coupling portions 17 of the at least one spring 15 are at least partially aligned along the alignment direction X-X to the first pad guide pin 12a and the second pad guide pin 12b, respectively.

According to an advantageous embodiment, the bracket 2 comprises a bracket body 2.1 configured to extend only partially straddling the brake disc 4. In particular, according to an embodiment, the bracket body 2.1 comprises a first bracket body part 2.6 which extends from only one side of the brake disc 4 and which is interposed between the first pad 6a, which is intended to be biased by the thrust means 5a, i.e., the pad 6 arranged axially closer to the first caliper body portion 3.1, and the caliper body sliding guide 11. According to an embodiment, the first bracket body part 2.1 is interposed, in particular, between the at least a first pad guide pin 12a and the at least one caliper body sliding guide or caliper body guide pin 11. According to an embodiment, the first bracket body part 2.6 is substantially “C”-shaped.

According to an embodiment, the bracket 2 comprises a bracket mounting element or bracket mounting hole 2.3, preferably two bracket mounting elements or bracket mounting holes 2.3. The at least one bracket assembly element 2.3 is configured to allow rigidly connecting the bracket 2 to a vehicle suspension by connection means, such as screws or bolts and nuts, for example.

According to an embodiment, the bracket body 2.1 comprise two bracket body arms 2a which project in a cantilevered manner and at least in the axial direction A-A from the first bracket body part 2.6. According to an embodiment, the bracket arms 2a are substantially “L”-shaped.

According to an embodiment, the bracket 2 comprises at least one bracket connection portion 2.2 which delimits a respective first bracket connection through-hole or first bracket connection channel 2.4 along the axial direction A-A. According to an embodiment, the first bracket connection through-hole 2.4 extends between a first bracket opening 2.5 and a second bracket opening 2.6. In an embodiment, the first bracket opening 2.5 faces the first caliper body portion 3.1 and the second bracket opening 2.6 faces the opposite side. According to an embodiment, the bracket 2 comprises two bracket connection portions 2.2 which preferably correspond to two opposite end portions of the first bracket body part 2.6. Each bracket connection portion 2.2 delimits a respective first bracket connection through-hole or first bracket connection channel 2.4 along the axial direction A-A.

According to an embodiment, the bracket 2 comprises at least a second bracket connection through-hole or second bracket connection channel 2.8 along the axial direction A-A. The at least a second bracket connection through-hole or second bracket connection channel 2.8 is opposite to or faces the first bracket connection through-hole 2.4. According to an embodiment, the at least a second bracket connection through-hole 2.8 is provided in at least one bracket body arm 2a and more preferably in a free end portion 2f of the bracket body arm 2a. According to an embodiment, the bracket 2 comprises two second bracket connection through-holes or second bracket connection channels 2.8 which are each provided in a respective bracket body arm 2a and are opposite to or each face a respective first bracket connection through-hole 2.4.

According to an embodiment, the at least one bracket coupling seat 2c is provided, in particular, in at least one of the bracket body arms 2a. According to an embodiment, the bracket 2 comprises a bracket coupling seat 2c on each bracket body arm 2a. According to an embodiment, the at least one bracket coupling seat 2c is a protruding seat projecting from the bracket 2, and more preferably from the bracket body arm 2a, in the aforesaid alignment direction X-X.

Advantageously, according to an embodiment, the bracket body 2.1 is in the shape of an open ring. In particular, according to an embodiment, the bracket body arms 2a comprise free end portions 2f being distal from the first bracket part 2.1. In other words, according to an embodiment, the bracket body 2.1 has no connection elements or portions between the bracket body arms 2a in addition to the first bracket part 2.1. In yet other words, the bracket body 2.1 comprises an interrupted bracket body section 2.7 between the free end portions 2f of the arms 2a, which is opposite to the first bracket body part 2.6. According to an embodiment, the length of the interrupted bracket body section 2.7, i.e., the distance L1 in a circumferential direction C-C between the free end portions 2f of the arms 2a, is equal or substantially equal to the distance L2 in a circumferential direction C-C between the bracket connection portions 2.2 (FIG. 12). By virtue of the provision of a bracket body 2.1 which extends only partially straddling the brake disc 4 and has an open-ring structure, it is conveniently possible to reduce the weight of the bracket 2 and simplify the processes for manufacturing the bracket 2. Furthermore, the open-ring structure of the bracket body 2.1 advantageously allows increasing the length of the reaction teeth 3e and thus reducing the residual torque.

According to an embodiment, the at least a first pad guide pin 12a is connected and coaxial to the at least one caliper body guide pin 11. Advantageously, the provision of such an integrated system for sliding the pad 6a and guiding the caliper body 3 ensures a reduction in the components and processes required to make the guide systems of pads 6a,6b and caliper body 3. Furthermore, the coaxial arrangement of the at least a first pad guide pin 12a and the at least one caliper body guide pin 11 advantageously allows reducing the residual torque.

According to an embodiment, the first pad guide pin 12a is reversibly connected to the caliper body guide pin 11. According to an embodiment, the first pad guide pin 12a comprises a coupling end portion 12.1 which passes through the first bracket connection through-hole 2.4 and is reversibly coupled to the caliper body guide pin 11. The coupling end portion 12.1 comprises a first segment 12.2 which extends into the first bracket connection through-hole 2.4 and a second end segment 12.3 which extends outside the first bracket connection through-hole 2.4 to couple in a mating coupling seat 11.1 provided in the caliper body guide pin 11. According to an embodiment, the first segment 12.2 extends exclusively into the first bracket connection through-hole 2.4. According to an embodiment, the second end segment 12.2 extends exclusively outside the first bracket connection through-hole 2.4.

According to an embodiment, the second end segment 12.3 is a threaded segment and the mating coupling seat 11.1 is a threaded coupling seat in which the second end segment 12.3 is screwed. According to an embodiment, the first segment 12.2 and the first connection through-hole 2.4 are threadless. In other words, according to an embodiment, the first segment 12.2 and the first bracket connection through-hole 2.4 form a coupling of the shaft/hole type with clearance. Advantageously, it is possible to avoid the first pad pin 12a from unscrewing accidentally when the caliper body guide pin 11 is unscrewed, e.g., if the first pad 6a needs to be replaced.

According to an embodiment, the at least a first pad guide pin 12a comprises an abutment portion or abutment flange 12.4 which is adapted to abut against the bracket 2 on the side of the second bracket opening 2.6 when the first pad guide pin 12a and the caliper body guide pin 11 are coupled together.

According to an embodiment, the caliper body guide pin 11 comprises an axially inner first end portion 11.2 and an axially outer second end portion 11.3. According to an embodiment, the first axially inner end portion 11.2 is adapted to abut against the bracket 2 on the side of the first bracket opening 2.5 when the first pad guide pin 12a and the caliper body guide pin 11 are coupled together. According to an embodiment, the axially inner end portion 11.2 comprises the mating coupling seat 11.1.

According to an alternative embodiment (not shown), the first pad guide pin 12a and the caliper body sliding pin 11 can be made in one piece. In this case, the first pad guide pin 12a and the caliper body sliding pin 11 will correspond to a pad guide portion and a caliper body sliding portion of a single pin 11,12a, respectively, having both the functions of pad sliding guide and caliper body sliding guide.

According to an embodiment, the axially outer second end portion 11.3 of the caliper body guide pin 11 comprises a manipulation seat 11.4 so that the end portion 11.3 is manipulable by a user and/or tool to couple and decouple the caliper body guide pin 11 to/from the first pad guide pin 12a.

According to an embodiment, the caliper body guide pin 11 comprises a pin sliding portion 11.5. The pin sliding portion 11.5 is slidingly housed in a respective sliding seat 3.5, which is obtained in the caliper body 3. According to an embodiment, the pin sliding portion 11.5 slides with respect to the sliding seat 3.5 directly in contact with the latter.

According to an embodiment, the at least a second pad guide pin 12b comprises a second-pin head 52 and a second-pin portion 53 which crosses the second bracket connection through-hole 2.8 and to which the second pad 6b is slidingly mounted. According to an embodiment, the second pin portion 53 comprises a first segment 53.1 which extends into the second bracket connection through-hole 2.8 and a second guide terminal segment 53.2 which extends outside the second bracket connection through-hole 2.8. According to an embodiment, the first segment 53.1 extends exclusively into the second bracket connection through-hole 2.8. According to an embodiment, the second end guide segment 53.2 extends exclusively outside the second bracket connection through-hole 2.8. According to an embodiment, the second bracket connection through-hole 2.8 is a threaded hole and the first segment 53.1 is a threaded segment screwed into the second bracket connection through-hole 2.8

According to one embodiment, the second guide end segment 53.2 is a smooth or threadless segment.

According to an embodiment, the second-pin head 52 is adapted to abut against the bracket 2 and more preferably against a respective free end portion 2f of a bracket body arm 2a.

According to an embodiment, the second-pin head 52 comprises a manipulation seat 52.1 so that the second-pin head 52 is manipulable by a user and/or a tool to couple and uncouple the second caliper body pin guide pin 12b to/from the bracket 2.

According to one embodiment, the brake caliper 1 comprises at least one dust sleeve 50,51 associated with the at least one caliper body guide pin 11. According to an embodiment, the brake caliper 1 comprises at least a first and a second dust sleeve 50,51 associated with the at least one caliper body guide pin 11.

According to an embodiment, each dust sleeve 50,51 is configured to avoid liquids and dust from entering into the respective sliding seat 3.5 and avoid liquids and dust from contacting the guide sliding portion 11.5.

According to an embodiment, each dust sleeve 50,51 comprises an extendable portion, e.g., a bellows-like portion, configured to elastically adapt to the sliding of the caliper body 3 with respect to the bracket 2.

According to an embodiment, the first sleeve 50 is fitted onto the end portion 11.3 of the guide pin 11 and is preferably engaged in appropriate coupling seats provided in the portion 11.3 and in the slide seat 3.5.

According to an embodiment, the second sleeve 51 is fitted onto the end portion 11.2 of the guide pin 11 and is preferably engaged in appropriate additional coupling seats provided in the portion 11.2 and in the sliding seat 3.5.

Based on the above description, it is thus possible to understand how a floating brake caliper according to the present invention allows achieving the objects mentioned above with reference to the prior art. Without prejudice to the principle of the invention, the embodiments and the constructional details may be broadly varied relative to the above description merely disclosed by way of a non-limiting example, without departing from the scope of the invention as defined in the appended claims.

1. A brake caliper (1) of the floating type of a disc brake (100) comprising:
a bracket or support element (2) configured to be connected to a vehicle,
a caliper body or floating element (3),
wherein the caliper body (3) comprises a first caliper body portion or caliper body vehicle-side portion (3.1), wherein the first caliper body portion (3.1) delimits at least one housing seat (5) for thrust means (5a);
wherein the caliper body (3) comprises a second caliper body portion or cantilevered caliper body portion (3.2), wherein the second caliper body portion (3.2) projects from the first caliper body portion (3.1) at least partially in the axial direction (A-A) so that the caliper body (3.2) can be arranged straddling a brake disc (4), wherein said second caliper body portion (3.2) comprises a first part (3a) of second caliper body portion which is opposite to said first caliper body portion (3.1);
at least one caliper body sliding guide or caliper body guide pin (11), wherein said at least one caliper body sliding guide (11) is arranged between said caliper body (3) and said bracket (2) to allow a relative sliding between said caliper body (3) and said bracket (2) along an axial direction (A-A);
at least a first and a second pad (6a,6b) having a support plate (7) and a friction material lining (8), said pads (6a,6b) being each positionable on a side of a brake disc (4) of said disc brake (100) facing opposite braking surfaces (4a) of a braking band (4b) of the brake disc (4);
said brake disc (4) being a rotor adapted to rotate about a rotation axis (10) which defines said axial direction (A-A), parallel to said rotation axis (10), a radial direction (R-R), orthogonal to said rotation axis (10), and a circumferential direction (C-C) orthogonal to said radial (R-R) and axial (A-A) directions;
pad guide elements (12a, 12b) interposed between said pads (6a,6b) and said bracket (2), wherein said pad guide elements (12a,12b) comprise at least one first pad guide pin (12a) supported by said bracket (2) and extending in the axial direction (A-A), at least said first pad (6a) being slidingly mounted to said first pad guide pin (12a) so as to allow said first pad (6a) to slide in the axial direction (A-A) along said first pad guide pin (12a);
at least one spring (15), shaped to be arranged straddling the brake disc (4) or to be arranged so as to extend from two opposite sides with respect to the brake disc (4), wherein said spring (15) applies an elastic bias to said pads (6a,6b) so as to elastically bias said pads (6a,6b) away from the brake disc (4) and so as to cause, by means of said second pad (6b), the caliper body to slide in said axial direction (A-A), in the direction in which the first part (3a) of second caliper body portion moves away from the brake disc (4);
wherein said spring (15) is also connected to said bracket (2) in addition to being connected to said pads (6a,6b).

2. A brake caliper (1) according to claim 1, wherein said bracket (2) comprises at least one bracket coupling seat or bracket fixing seat (2c) to which said at least one spring (15) is connected, said bracket coupling seat (2c) being located at a predetermined portion of the bracket (2) intended to be aligned with a centerline plane (4c) of said braking band (4b) which is orthogonal to said axial direction (A-A).

3. A brake caliper (1) according to claim 2, wherein said spring (15) defines a spring symmetry plane (16) and either comprises or consists of two side spring coupling portions or lateral spring arms (17) and a central spring coupling portion or central spring arm (41), which is interposed between, and either connected to or joined to, said side spring coupling portions (17), wherein said side spring coupling portions (17) are symmetrical with respect to the spring symmetry plane (16) and are configured to engage two respective opposite plate engagement portions (37) of said pads (6a,6b), wherein said central spring coupling portion (41) is configured to couple to the bracket (2), wherein said spring (15) is arranged so that said spring symmetry plane (16) either coincides or substantially coincides with the centerline plane (4c) of said braking band (4b) of the brake disc (4).

4. A brake caliper (1) according to claim 3, wherein said central spring coupling portion (41) is fixed to said bracket coupling seat (2c);
and/or wherein
said central spring coupling portion (41) extends either mainly or entirely along a direction parallel to said spring symmetry plane (16).

5. A brake caliper (1) according to claim 3, wherein said central spring coupling portion (41) is fixed to said bracket (2) so as to maintain the central spring coupling portion (41) in a fixed position at least in the axial direction (A-A) so as to prevent said central spring coupling portion (41) from moving in the axial direction (A-A) with respect to said bracket (2).

6. A brake caliper (1) according to claim 3, wherein said bracket (2) defines a bracket symmetry plane (2d) orthogonal to said spring symmetry plane (16), and wherein at least one of the side spring coupling portions (17) is at least partially aligned with said first pad guide pin (12a) along an alignment direction (X-X) orthogonal to a plane which is orthogonal to both said spring symmetry plane (16) and said bracket symmetry plane (2d).

7. A brake caliper (1) according to claim 6, wherein said pad guide elements (12a, 12b) comprise at least a second pad guide pin (12b) supported by said bracket (2) and extending in the axial direction (A-A), wherein said second pad guide pin (12b) is opposed to and faces said first pad guide pin (12a), said second pad (6b) being slidingly mounted to said second pad guide pin (12b) so as to allow said second pad (6b) to slide in the axial direction (A-A) along said second pad guide pin (12b);
wherein the two side spring coupling portions (17) are at least partially aligned along said alignment direction (X-X) to said first pad guide pin (12a) and said second pad guide pin (12b), respectively.

8. A brake caliper (1) according to claim 1, wherein said spring (15) is exclusively connected to said pads (6a,6b) and said bracket (2).

9. A brake caliper (1) according to claim 1, wherein said spring (15) is a strip spring.

10. A brake caliper (1) according to claim 1, wherein said bracket (2) comprises a bracket body (2.1) configured to extend only partially straddling the brake disc (4), wherein said bracket body (2.1) comprises:
a first bracket body part (2.6) which extends from only one side of said brake disc (4) and which is interposed between said first pad (6a), intended to be biased by said thrust means (5a), and said caliper body sliding guide (11);
two bracket body arms (2a) projecting in a cantilevered manner and at least in the axial direction (A-A) from said first bracket body part (2.6); and
said bracket coupling seat (2c) being provided in at least one of said bracket body arms (2a);
and/or wherein
said first bracket body part (2.1) is interposed between said first pad guide pin (12a) and said caliper body sliding guide (11);
and/or wherein
said bracket arms (2a) are substantially “L”-shaped.

11. A brake caliper (1) according to claim 10, wherein said bracket body (2.1) is in the shape of an open ring,
and/or wherein said bracket body arms (2a) comprise free end portions (2f) distal from the first bracket part (2.1),
and/or wherein the bracket body (2.1) is free from connection elements or portions between said bracket body arms (2a) in addition to the first bracket part (2.1).

12. A brake caliper (1) according to claim 1, wherein said first pad guide pin (12a) is connected and coaxial to said caliper body guide pin (11).

13. A brake caliper (1) according to claim 12, wherein the bracket (2) comprises at least one bracket connection portion (2.2) which delimits a respective first bracket connection through-hole or bracket connection channel (2.4) along the axial direction (A-A), wherein said first pad guide pin (12a) comprises a coupling end portion (12.1) which crosses said first bracket connection through-hole (2.4) and is reversibly coupled to the caliper body guide pin (11), wherein said coupling end portion (12.1) comprises a first segment (12.2) extending into said first bracket connection through-hole (2.4) and a second end segment (12.3) extending outside the first bracket connection through-hole to couple in a mating coupling seat (11.1) provided in the caliper body guide pin (11).

14. A disc brake (100) comprising a brake caliper (1) according to claim 1.
